(19) United States
(12) Patent Application Publication
(10) Pub. No.: US 2022/0401309 A1
(43) Pub. Date: Dec. 22, 2022

(54) IMPROVEMENTS RELATING TO THE MANUFACTURE AND DESIGN OF ARTIFICIAL TEATS

(71) Applicant: Ross Gordon MCINNES, Waipu (NZ)

(72) Inventor: Ross Gordon MCINNES, Waipu (NZ)

(21) Appl. No.: 17/764,047

(22) PCT Filed: Sep. 25, 2020
(86) PCT No.: PCT/NZ2020/050110

§ 371 Date: Mar. 25, 2022

(30) Foreign Application Priority Data
Sep. 27, 2019 (NZ) 757655
Sep. 2, 2020 (NZ) 767633

(51) Int. Cl. A61J 11/00; A01K 9/00

(52) U.S. Cl. CPC A61J 11/0065; A01K 9/005

(57) ABSTRACT

A problem with artificial teats for infants or young animals is that with repeated use the opening in the nipple end of the teat usually becomes enlarged causing a change in the flow rate though the teat. Disclosed is an artificial teat that is made of an elastomeric material and which includes a base end and a nipple end. The base end is configured to mate with a container or liquid supply, and the nipple end has one or more slits through which a liquid is able to flow when an infant or young animal is suckling. And the artificial teat includes a body member in which the or each slit is cut, and the body member has at least one slit assist member that is formed or made separate to the body member and which is integrated into the body member during manufacture.

### CROSS-REFERENCE RELATED TO PRIOR APPLICATIONS

This application is the U.S. national phase of International Application No. PCT/NZ2020/050110 filed Sep. 25, 2020 which designated the U.S. and claims priority to NZ 757655 filed Sep. 27, 2019 and NZ 767633 filed Sep. 2, 2020, the entire contents of each of which are hereby incorporated by reference.

### BACKGROUND OF THE INVENTION

### Field of the Invention

This invention relates to teats for feeding infants and small animals, and in particular, but not exclusively to teats for feeding new born calves, lambs or goats.

### Description of the Related Art

It is common for artificial feeding teats to be made from elastomers. These artificial teats will typically have a slit or slits made in the end of the teat. The slit is often made by cutting through the elastomeric material of the end of the teat. The slit or slits allow milk, a milk substitute, or other fluid to flow in a relatively controlled manner from the teat and into the mouth of an infant or young animal being fed. The slit or slits preferably open when the teat is squeezed by the infant or young animal's suckling or biting action, allowing the fluid to flow as they suckle.

Some teats have a one way valve between the teat and the fluid container which allows fluid to flow into the teat but closes under back pressure from in infants suckling or biting action to prevent the fluid flowing back into the container, thus forcing the fluid through the slit or slits and into the infants mouth when the infants biting or sucking action squeezes the teat.

Some teats have an internal web to control the amount that the slit opens and ensure a regulated flow of milk is delivered. Such teats are described in New Zealand patents 244008/250873. Such teats with only one slit are unidirectional in use, i.e. they should preferably be used with the length of the slit in line with the infants bite for the slit to open to allow fluid to flow, unless a one way valve is fitted to force fluid out through the slit as the teat is squeezed by the infants sucking or biting action.

Other teats have two or more slits in an X pattern or a Y pattern. These teats may be used with the slits in any orientation, however using such a teat with one or more slits in line with the infant's bite puts greater opening stress on the ends of the slit than when the infants bite is at a lesser angle to slit or slits.

Other teats can have one or more slits in the side wall of the teat that are aligned relative to the axis of the body of the teat.

The one thing that all such teats have in common is that the repeated opening and closing of the slit or slits as the infant bites repeatedly on the teat, causes the ends of the slit or slits to migrate outwards, allowing a greater flow of feed over time with repeated use. The increased flow of feed can cause discomfort and health problems in infants that are feeding too fast. Similarly, the slit in the web of a unidirectional teat with a single web will migrate along the length of the web, thus reducing the closing force applied to the slit.

Manufacturers use different techniques in an effort to stop, or at least slow down slit migration. One method is to mould stress relieving cavities into the teat and cut the slit between said cavities as described in NZ Patent 244008. Another method is to make the teat wall thicker immediately adjacent to the ends of the slit as in Patents JP2016140474A and U.S. Pat. No. 5,769,285A. Both of these methods provide short term relief only, even with the use of high tear strength elastomers.

What is needed is a better method of manufacturing teats or a better teat design that will help to maintain the forces that keep the slit closed in between suckling actions, and a better method of manufacturing teats or a better teat design that will help slow down or prevent tearing at the edges of the teat slits.

In this specification unless the contrary is expressly stated, where a document, act or item of knowledge is referred to or discussed, this reference or discussion is not an admission that the document, act or item of knowledge or any combination thereof was at the priority date, publicly available, known to the public, part of common general knowledge; or known to be relevant to an attempt to solve any problem with which this specification is concerned.

### SUMMARY OF THE INVENTION

It is therefore an object of the present invention to provide a teat design that will at least go some way towards overcoming one or more of the above mentioned problems, or at least provide the public with a useful choice.

Accordingly, in a first aspect, the invention may broadly be said to consist in an artificial teat for infants or young animals, the artificial teat being made of an elastomeric material and having a base end and a nipple end, the base end being configured to mate with a container or liquid supply, and the nipple end having one or more slits through which a liquid is able to flow when an infant or young animal is suckling, and wherein the artificial teat includes a body member in which the or each slit is cut or formed, and at least one slit assist member, the or each slit assist member being formed or made separate to the body member and being integrated into the body member.

Preferably the or each slit assist member is bonded to the body member.

Preferably the or each slit assist member is situated within the nipple end of the artificial teat.

Preferably the or each slit assist member is positioned in such a manner within the artificial teat that a part of the or each slit assist member is situated adjacent to an edge of the or each slit in the artificial teat.

Preferably the or each slit assist member is positioned in such a manner within the artificial teat that a part of the or each slit assist member lies substantially at right angles to an adjacent edge of the or each slit in the artificial teat.

Preferably the or each slit assist member is in the form of an elongate member.

Preferably the or each slit assist member is substantially dogbone shaped.

Optionally one or more of the slit assist members are in the form of an o-ring.

Preferably the or each o-ring shaped slit assist member encircles a slit of the artificial teat.

Optionally one or more o-ring shaped slit assist member includes a cap portion.

Preferably the or each slit assist member is configured to assist in keeping the or each slit closed.

Preferably the or each slit assist member is configured to assist by acting as a tear stopping device to slow down or stop the or each slit from tearing and increasing in size when in use.

Preferably the artificial teat is formed by overmolding the body member over the or each slit assist member.

Preferably the or each slit assist member is made from the same, or a similar, elastomeric material as the body member.

Preferably the or each slit assist member is pre-tensioned during the time that the body member is overmolded about the or each slit assist member.

In a second aspect, the invention may broadly be said to consist in a feeding apparatus incorporating at least one artificial teat substantially as specified herein.

Preferably the feeding apparatus includes at least one bottle, trough or milk supply apparatus.

In a third aspect, the invention may broadly be said to consist in a method of manufacturing an artificial teat substantially as specified herein wherein the method includes the steps of;
producing one or more slit assist members,
installing the or each slit assist member within the molding tooling for making the artificial teat, and
overmolding a body member of the artificial teat about the or each slit assist member.

Preferably the method includes pre tensioning the or each slit assist member when installing it into the molding tooling and during the overmolding step.

The invention may also broadly be said to consist in the parts, elements and features referred to or indicated in the specification of the application, individually or collectively, and any or all combinations of any two or more of the parts, elements or features, and where specific integers are mentioned herein which have known equivalents, such equivalents are incorporated herein as if they were individually set forth.

### BRIEF DESCRIPTION OF THE DRAWINGS

Further aspects of the present invention will become apparent from the following description which is given by way of example only and with reference to the accompanying drawings in which:

FIG. 1 is a cutaway perspective view of a first example of an artificial teat according to the present invention,

FIG. 2 is a cross sectional view of the first example of an artificial teat, the cross section being taken at right angles to a slit within the artificial teat,

FIG. 3 is a perspective view of a slit assist member of the first example of an artificial teat,

FIG. 4 is a cross sectional view of the first example of an artificial teat, the cross section being taken in line with the slit in the artificial teat,

FIG. 5 is a cross sectional view AA of the first example of an artificial teat,

FIG. 6 is a perspective view of a nipple end portion of a mandrel of a molding tool for manufacturing the first example of an artificial teat,

FIG. 7 is a cutaway perspective view of a second example of an artificial teat according to the present invention,

FIG. 8 is a cross sectional view of the second example of an artificial teat, the cross section being taken in line with the slit in the artificial teat,

FIG. 9 is a cross sectional view of the second example of an artificial teat, the cross section being taken at right angles to a slit within the artificial teat,

FIG. 10 is a cross sectional view BB of the second example of an artificial teat,

FIG. 11 is a perspective view of a nipple end portion of a mandrel of a molding tool for manufacturing the second example of an artificial teat,

FIG. 12 is a cutaway perspective view of a third example of an artificial teat according to the present invention,

FIG. 13 is a cross sectional view of the third example of an artificial teat, the cross section being taken in line with a slit in the artificial teat,

FIG. 14 is a plan view of the third example of an artificial teat,

FIG. 15 is a cutaway perspective view of a part of a molding cavity for use in manufacturing the third example of an artificial teat,

FIG. 16 is a cutaway perspective view of a fourth example of an artificial teat according to the present invention,

FIG. 17 is a cross sectional view of the fourth example of an artificial teat, the cross section being taken in line with one part of a cross shaped slit in the artificial teat,

FIG. 18 is a cross sectional view CC of the fourth example of an artificial teat,

FIG. 19 is a perspective view of a nipple end portion of a mandrel of a molding tool for manufacturing the fourth example of an artificial teat,

FIG. 20 is a cross sectional view of a fifth example of an artificial teat according to the present invention, the cross section being taken in line with one of three slits in the artificial teat,

FIG. 21 is a cross sectional view of a cap shaped slit assist member of the fifth example of an artificial teat,

FIG. 22 is a cross sectional view DD of the fifth example of an artificial teat,

FIG. 23 is a perspective view of a nipple end portion of a mandrel of a molding tool for manufacturing the fifth example of an artificial teat,

FIG. 24 is a perspective view of a sixth example of an artificial teat according to the present invention,

FIG. 25 is a perspective view of a slit assist member of the sixth example of an artificial teat,

FIG. 26 is a side elevation view of the sixth example of an artificial teat in which a cross sectional plane EE is defined,

FIG. 27 is a cross sectional view EE of the sixth example of an artificial teat,

FIG. 28 is a bottom plan view of the sixth example of an artificial teat,

FIG. 29 is a cross sectional perspective view of the sixth example of an artificial teat in which a detailed view F is defined,

FIG. 30 is a detailed view F of a nipple end portion of the sixth example of an artificial teat,

FIG. 31 is a perspective view of a seventh example of an artificial teat according to the present invention,

FIG. 32 is a perspective view of a slit assist member of the seventh example of an artificial teat,

FIG. 33 is a bottom plan view of the seventh example of an artificial teat,

FIG. 34 is a side elevation view of the seventh example of an artificial teat in which a cross sectional plane GG is defined,

FIG. 35 is a cross sectional view GG of the seventh example of an artificial teat,

FIG. 36 is a cross sectional perspective view of the seventh example of an artificial teat in which a detailed view H is defined, and

FIG. 37 is a detailed view H of a nipple end portion of the seventh example of an artificial teat.

### DESCRIPTION OF THE PREFERRED EMBODIMENTS

### First Example

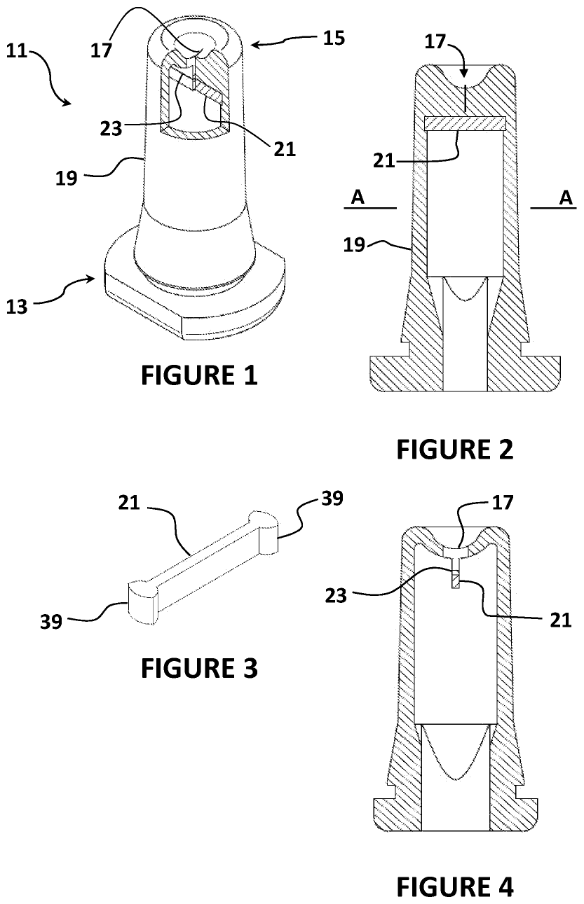

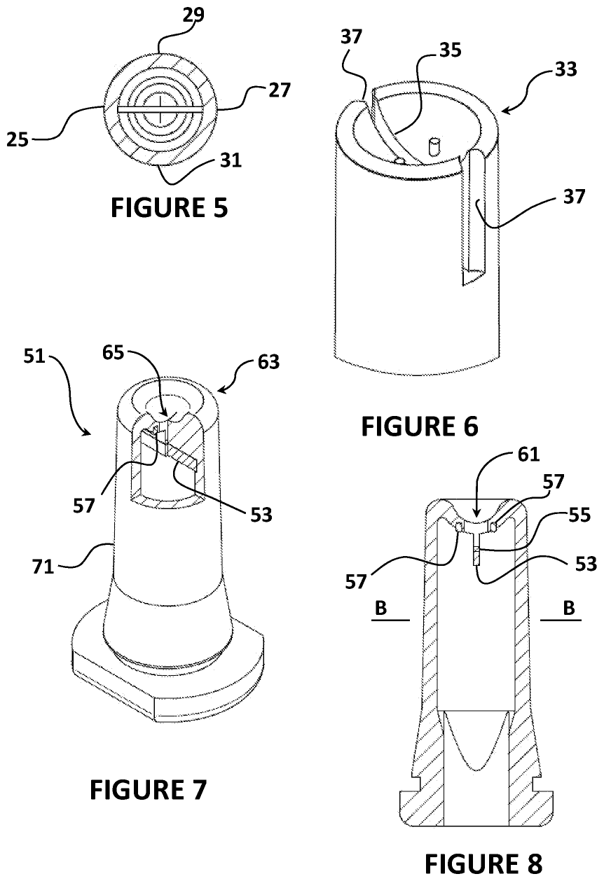

With reference to FIGS. 1 to 6, a first example of an artificial teat (11) according to the present invention will now be described. This first example of an artificial teat (11) has been designed for use in a feeding apparatus such as a calf or lamb feeding trough or a feeding machine. Alternative forms of the artificial teat could be used for feeding babies or infants and could be configured to fit onto a feeding bottle.

The artificial teat (11) is made of an elastomeric material and has a base end (13) and a nipple end (15). The base end (13) is configured to mate with a container or liquid supply, for example a calf feeding trough as noted above, or a milk supply apparatus, for example a computerised or electronic mixing milk supply apparatus. In this example, the nipple end (15) has a slit (17) through which a liquid such as milk is able to flow when a young animal is suckling from it. It can also be seen that the nipple end (15) is inverted, or is concave as opposed to a rounded or convex shape of many other teats.

The artificial teat (11) is made up primarily of a body member (19) in which the slit (17) or slits are cut or formed. Importantly, the artificial teat (11) also includes a slit assist member (21) which is integrated into the body member (19) and is situated within the nipple end (15) of the artificial teat (11). In this example, the slit assist member (21) is a part of a web (23) which spans between a left side (25) and a right side (27) of the artificial teat (11).

This first example of an artificial teat (11) is designed to be used with the slit (17) aligned with a biting motion of a child or young animal. That is, as the child or young animal closes its jaw during a suckling action, the ends of the slit (17) will be pushed together causing the slit (17) to open and to allow milk to pass. In this way, the child or young animal applies pressure to an upper wall (29) and a lower wall (31) of the body member (19) to cause milk to flow. The web (23) which spans between the left side (25) and the right side (27) of the body member (19) resists this action and causes the body member (19) to return to a round shaped when the suckling action is stopped. In this way the slit (17) is caused to close again, preventing milk draining into the baby or young animal's mouth in between suckling actions, or to prevent leakage if the teat is released.

This is where the slit assist member (21) comes into play. The slit assist member (21) is positioned and configured in such a way that is assists in keeping the slit (17) closed in between suckling actions. The slit assist member (21) performs this function in two ways; firstly, it can be pre-tensioned during manufacture of the artificial teat (11) and therefore provides an increased slit closing force over the material of the remainder of the web (23), and secondly, it helps to stop tearing at the edges of the slit (17).

Tearing at the edges of the slit (17), or slit creep, is common in artificial teats and results in the slit (17) becoming larger and a weakening of the web (23). The combination of these effects results in milk leakage though the slit (17) in between the baby or young animal's suckling actions, and too much milk flow through the slit (17) during suckling actions.

To achieve these two objectives, it is necessary to manufacture or form the slit assist member (21) separately to the manufacture of the body member (19), and then to attach or bond the slit assist member (21) to the body member (19) during the manufacture of the artificial teat (11). It is important to note that the slit assist member (21) is cured or vulcanised before it is placed within a mold to produce the body member (19).

To achieve the bonding between the slit assist member (21) and the body member (19), the artificial teat (11) is formed by overmolding the body member (19) over, or onto, the slit assist member (21). The slit assist member (21) is ideally made from the same, or a similar, elastomeric material as the body member (19) to allow successful bonding. The slit assist member (21) is ideally made from any elastomeric material that will bond with the unvulcanised or uncured elastomer used to make the body member (19).

The slit assist member (21) is optionally pre-tensioned during the time that the body member (19) is overmolded about the slit assist member (21). For example the slit assist member (21) can be stretched by 10% to 20% to provide a pre-tension in the slit assist member (21) when the artificial teat (11) is manufactured. The pre-tension can assist in holding the slit (17) closed in between suckling actions. The pre-tension can also help to keep the nipple end (15) of the body member (19) round, as the artificial teat (11) is subject to continued use and it ages.

In FIG. 3 it can be seen that the slit assist member (21) is in the form of an elongate member, and has something of a dog-bone shape in that it has enlarged or bulbed ends (39). FIG. 6 shows the nipple end of a mandrel (33) of the molding tooling used to create the shape of the inside of the nipple end (15) of the artificial teat (11). The mandrel (33) includes a slot (35) that is used to create the web (23). The two opposing ends (37) of the slot (35) are bevelled to accommodate the bulbed ends (39) of the slit assist member (21). By capturing the bulbed ends (39) of the slit assist member (21) within the bevelled ends (37) of the slot (35) it is possible to hold the slit assist member (21) in tension during the overmolding process.

To achieve the second objective, that of minimising slit edge tearing, the slit assist member (21) is situated so that a middle section of the slit assist member (21) is positioned adjacent to an inside edge of the slit (17), as can be seen in FIGS. 2 and 4. In these figures it can be seen that the slit assist member (21) is positioned in such a manner within the artificial teat (11) that a part of the slit assist member lies (21) substantially at right angles to an adjacent edge of the slit (17).

In this location and orientation, the slit assist member (21) assists the slit (17) by acting as a tear stopping device to slow down or stop the slit (17) from tearing and increasing in size when in use. The slit (17) will inevitably tear and enlarge through the elastomer that forms the body member (19) but when the tear reaches the junction with the slit assist member lies (21) the tear will stop, at least for a time. Testing has shown that the life of an artificial teat (11) can be increased by incorporating the slit assist member (21).

The method of manufacturing the artificial teat (11) can be described as follows;
producing the slit assist member (21),
install the slit assist member (21) within the molding tooling for making the artificial teat (11), and
overmold the body member (19) of the artificial teat (11) about the slit assist member (21).

The method can optionally include pre tensioning the slit assist member (21) when installed it into the molding tooling and during the overmolding step.

### Second Example

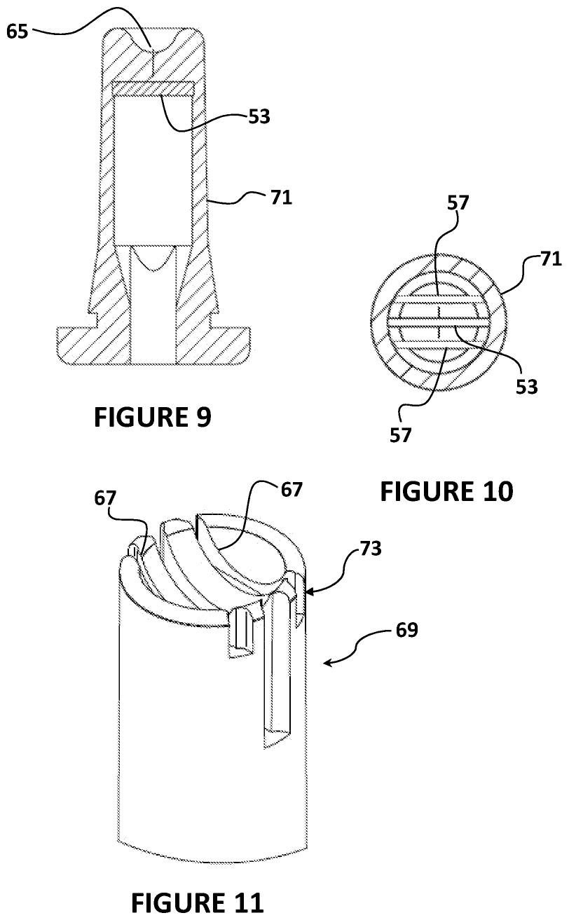

With reference to FIGS. 7 to 11, a second example of an artificial teat (51) will now be described. The second example of an artificial teat (51) is similar in many ways to the first example of an artificial teat (11) described herein. The only difference is the addition of two more elongate slit assist members.

In addition to a slit assist member (53) situated within a web (55) of the teat (51), the teat (51) also includes two slightly shorter slit assist members (57) that are situated within the concave part (61) of a nipple end (63) of the teat (51). The two slit assist members (57) are situate with one at each end of a slit (65) in the nipple end (63).

In this way, tearing of the slit (63) at both ends of the slit, and at the base of the slit can be stopped by the slit assist members (53) and (57). The slit assist members (53) and (57) also perform a function of helping to keep the slit (65) closed and help to further minimise milk leakage.

FIGS. 10 and 11 show two additional slots (67) in a mandrel (69) for producing the nipple end of the teat (51). The two slightly shorter slit assist members (57) are held within the two additional slots (67) during manufacture of a body member (71) of the teat (51). Clearly the two shorter slit assist members (57) can also be tensioned if desired during the teat (51) manufacture. As with the first example, bulbed ends of the slit assist members (57) can be held within sockets or bevelled ends (73) of the additional slots (67).

### Third Example

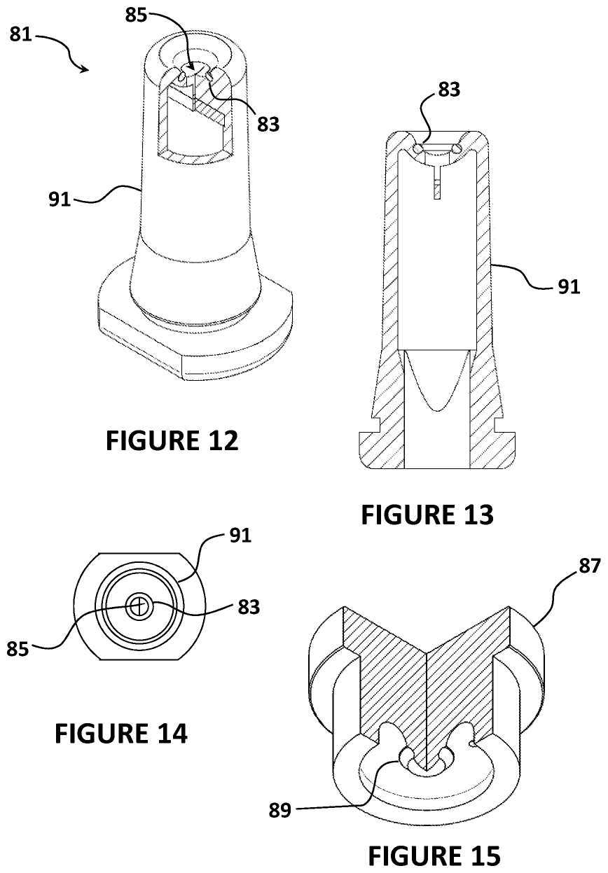

With reference to FIGS. 12 to 15 a third example of an artificial teat (81) will now be described. The third example of an artificial teat (81) is similar in many ways to the second example of an artificial teat (51) described herein, except that the two additional elongate slit assist members (57) of the artificial teat (51) are replaced with a single o-ring shaped slit assist member (83).

The o-ring shaped slit assist member (83) encircles a slit (85) of the artificial teat (81). In this way, the o-ring shaped slit assist member (83) is positioned well to help by applying pressure to keep the slit (85) closed when the teat (81) is not being suckled. In addition, the o-ring shaped slit assist member (83) is well positioned to act as a tear stopping device to significantly slow down the rate at which the slits tears and increases in size over time.

FIG. 15 shows a part of a molding cavity (87) for use in manufacturing the artificial teat (81). The molding cavity (87) includes a groove (89) for holding the o-ring shaped slit assist member (83) in an appropriate location during the manufacture of a body member (91) of the teat (81). Depending on the size of the o-ring shaped slit assist member (83) to the size of the groove (89), the o-ring shaped slit assist member (83) can be pre-tensioned during the body member (91) manufacturing process.

### Fourth Example

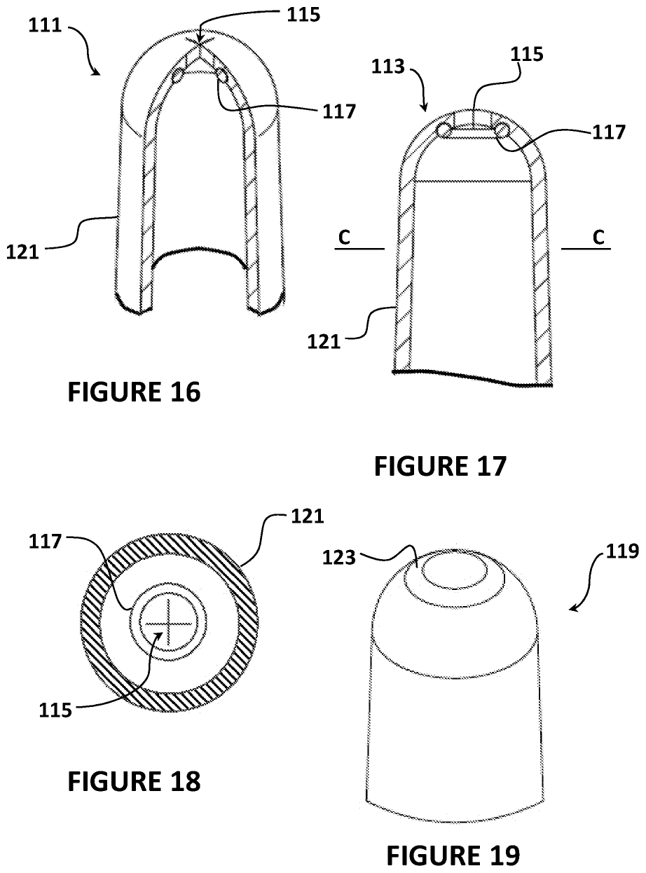

With reference to FIGS. 16 to 19, a fourth example of an artificial teat (111) will now be described. This fourth example of an artificial teat (111) is different from the previous examples in that it has a convex nipple end (113) and a cross shaped slit (115), and no web portion within the nipple end.

In this example, the teat (111) includes a single slit assist member (117) which is in the form of an o-ring. As with the third example of an artificial teat (81) described herein, the slit assist member (117) encircles the slit (115), and carries out the same function as the o-ring (83) in the teat (81). As an alternative to an o-ring shaped slit assist member (117), a cylindrical shaped slit assist member (117) could be used.

FIG. 19 shows the nipple end of a mandrel (119) for use in producing a body member (121) of the teat (111). The mandrel (119) includes a groove (123) for holding the slit assist member (117) in an appropriate location during the manufacture of the body member (121).

### Fifth Example

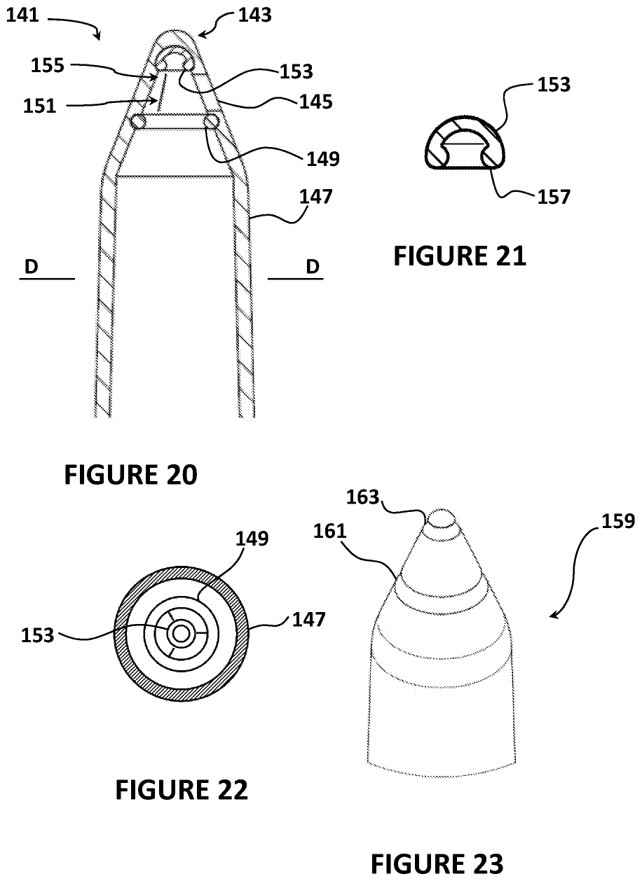

With reference to FIGS. 20 to 23, a fifth example of an artificial teat (141) will now be described. This fifth example of an artificial teat (141) has a conical or tapered nipple end (143) that is provided with three separate slits (145) equally spaced about the nipple end (143). The slits (145) are each aligned longitudinally with respect to a body member (147) of the teat (141).

The teat (141) includes two slit assist members. A first slit assist member (149) is situated adjacent to a base end (151) of the slits (145) and is in the form of an o-ring. A second slit assist member (153) is situated adjacent to a tip end (155) of the slits (145) and is in the form of a cap, the cap having a bulbous edge portion (157). The bulbous edge portion (157) resembles an o-ring. It is thought prudent to form the second slit assist member (153) in the form of a cap over an o-ring shape to help the second slit assist member (153) to stay in place during the manufacture of the body member (147). During manufacture of the body member (147) by injection molding, the elastomer is injected at high speed and can dislodge the slit assist members if they are not held securely onto the mandrel (159).

FIG. 23 shows the nipple end of the mandrel (159) for use in the molding tooling to produce the teat (141). It can be seen that a conical shaped end of the mandrel includes a larger groove (161) for holding the first slit assist member (149) and a smaller groove (163) for holding the second slit assist member (153). Again the slit assist members can be pre-tensioned during manufacture of the teat (141).

The two slit assist member perform a similar function to the slit assist members of the other teat examples described herein in that they both provide tension to help keep the slits (145) closed, and they both act as tear stoppers to help slow down the tearing that inevitably occurs at the edges of the slits (145).

### Sixth Example

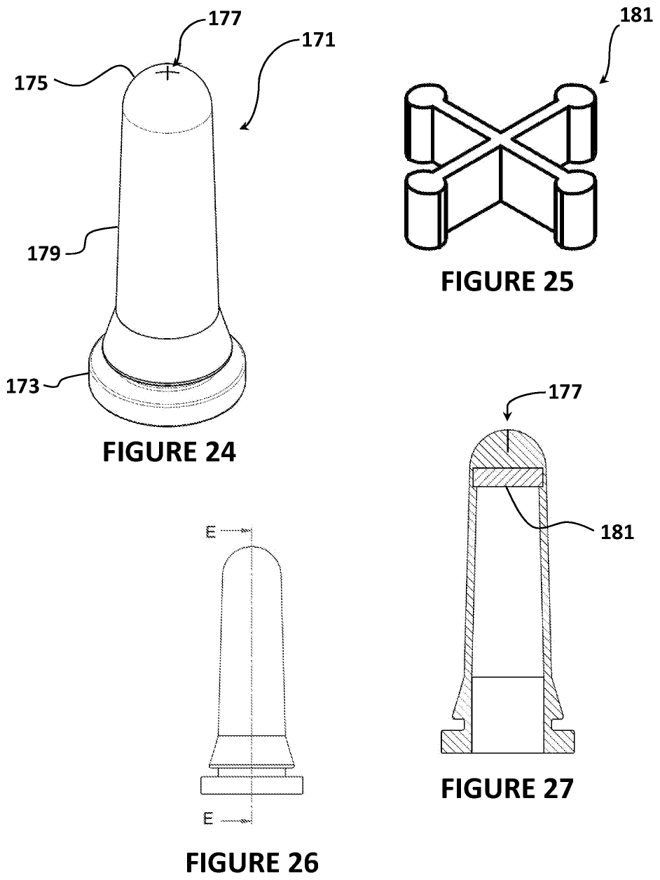

With reference to FIGS. 24 to 30, a sixth example of an artificial teat (171) according to the present invention will now be described. As with the previous examples of artificial teats described herein, this sixth example of an artificial teat (171) has been designed for use in a feeding apparatus such as a calf or lamb feeding trough or a feeding machine. Alternative forms of the artificial teat could be used for feeding babies or infants and could be configured to fit onto a feeding bottle.

The sixth example of an artificial teat (171) is made of an elastomeric material and has a base end (173) and a nipple end (175). The base end (173) is configured to mate with a container or liquid supply, and the nipple end (175) has a cross shaped slit (177) through which a liquid is able to flow when an infant or young animal is suckling.

The artificial teat (171) can also be said to comprise a tubular shaped body member (179), one end of which is open and forms the base end (173), and the opposite end of which is closed and forms the nipple end (175). It is the nipple end (175) of the body member (179) in which the cross shaped slit (177) is formed. And, with reference to FIGS. 27 to 30, it can be seen that the artificial teat (171) also includes a slit assist member (181) which is positioned adjacent to the slit (177).

The slit assist member (181) is a part of the artificial teat (171) that is made or formed separate to the manufacture of the body member (179), and which is later integrated into the body member (179) when the body member (179) is injection molded. The slit assist member (181) is ideally made from the same, or a similar, elastomeric material as the body member (179). And the entire artificial teat (171) is formed by overmolding the body member (179) over the slit assist member (181) in such a manner that the slit assist member (181) becomes bonded to the body member (179).

The slit assist member (181) is situated within the nipple end of the artificial teat adjacent to a deepest edge of the slit (177) in the artificial teat (171). The slit assist member (181) is positioned in such a manner within the artificial teat (171) that a part of the slit assist member (181) lies substantially at right angles to the adjacent edge of the slit (177).

As can be seen in FIG. 25, in this example the slit assist member (181) is in the form of a cross shaped member, the cross shape essentially comprising two dogbone shaped elongate members lying at right angles to one another and joined at a central point along the length of each elongate member.

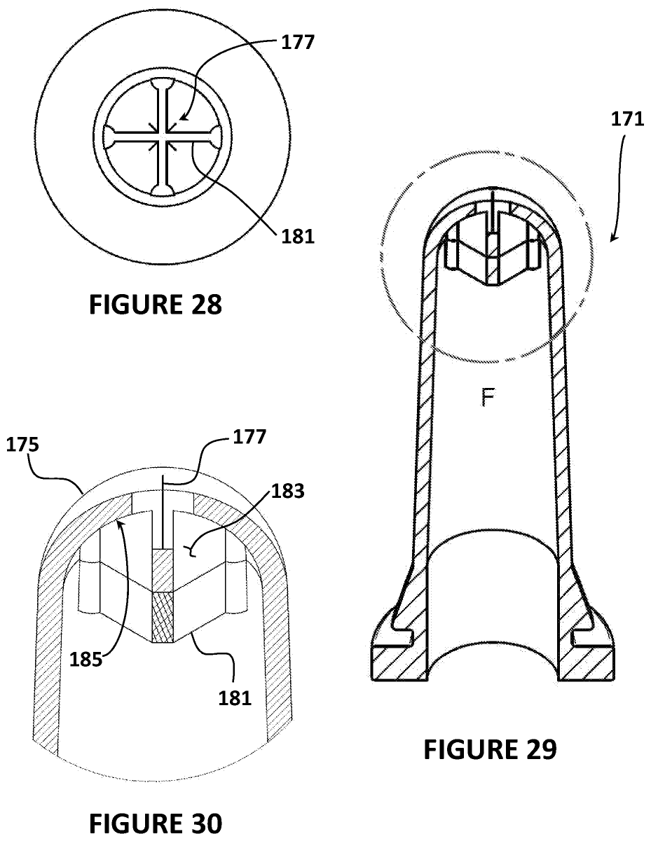

In FIG. 28 it can be seen that the nipple end (175) of the teat body (179) includes two intersecting webs that form a cross shaped web (183) which extends towards the base end from a concave inner surface (185) of the nipple end (175). The cross shaped slit assist member (181) is aligned with the cross shaped web (183) and is bonded to its edge as can be seen in FIG. 30. In FIG. 28 it can also be seen that the cross shaped slit (177) is offset by forty five degrees compared to the cross shaped web (183). In this way, the cross shaped slit (177) is cut through the body (179) for a short distance either side of a tip of the nipple end (175), and the slit (177) extends a short distance into the centre region of the cross shaped web (183).

The slit assist member (181) acts in two ways. Firstly, it is configured to assist the cross shaped web (183) in keeping the slit (177) closed. And secondly, the slit assist member (181) is configured to assist the slit (177) by acting as a tear stopping device to slow down or stop the edges of the slit (177) in the cross shaped web (183) from tearing and increasing in size during repeated usage.

To help the slit assist member (181) to achieve these two objectives, the slit assist member (181) is pre-tensioned during the time that the body member (179) is overmolded about the slit assist member (181).

### Seventh Example

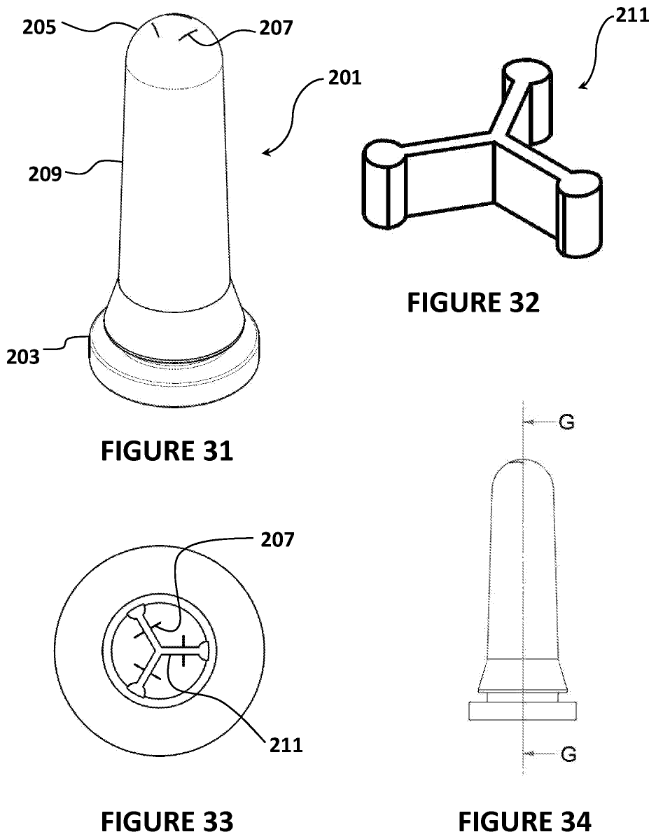

With reference to FIGS. 31 to 37, a seventh example of an artificial teat (201) according to the present invention will now be described. This seventh example of an artificial teat (201) has been designed for use in a feeding apparatus such as a calf or lamb feeding trough or a feeding machine. Alternative forms of the artificial teat could be used for feeding babies or infants and could be configured to fit onto a feeding bottle.

The seventh example of an artificial teat (201) is made of an elastomeric material and has base end (203) and a nipple end (205). The base end (203) is configured to mate with a container or liquid supply, and the nipple end (205) has three short and straight slits (207) through which a liquid, such as milk, is able to flow when an infant or young animal is suckling. The slits (207) are equally spaced in a substantially circular arrangement centred about a tip of the nipple end (205).

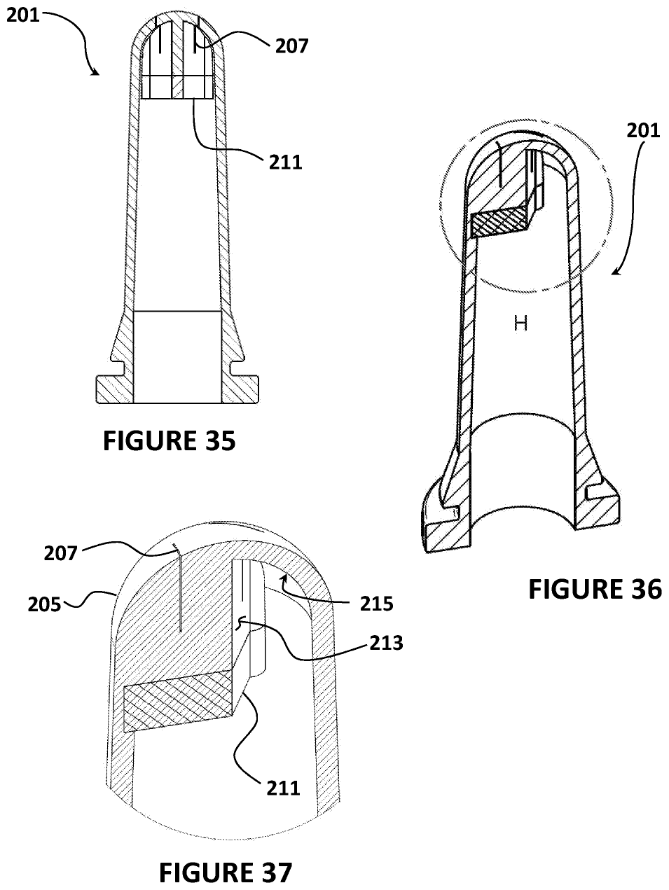

The artificial teat (201) can also be said to comprise a tubular shaped body member (209), one end of which is open and forms the base end (203), and the opposite end of which is closed and forms the nipple end (205). It is the nipple end (205) of the body member (209) in which the three short and straight slits (207) are formed. And, with reference to FIGS. 35 to 37, it can be seen that the artificial teat (201) also includes a slit assist member (211) which is positioned adjacent to the slits (207).

The slit assist member (211) is a part of the artificial teat (201) that is made or formed separate to the manufacture of the body member (209), and is later integrated into the body member (209) when the body member (209) is formed by injection molding. The slit assist member (211) is ideally made from the same, or a similar, elastomeric material as the body member (209). And the entire artificial teat (201) is formed by overmolding the body member (209) over the slit assist member (211) in such a manner that the slit assist member (211) becomes bonded to the body member (209) is becomes an integral part of the artificial teat (201).

The slit assist member (211) is situated within the nipple end of the artificial teat adjacent to a deepest edge of each of the slits (207) in the artificial teat (201). The slit assist member (211) is positioned in such a manner within the artificial teat (201) that a part of the slit assist member (211) lies substantially at right angles to the adjacent edge of each of the slits (207).

As can be seen in FIG. 32, in this example the slit assist member (211) is in the form of a three legged member. In FIG. 33 it can be seen that the nipple end (205) of the teat body (209) includes three intersecting webs (213), with each of the webs aligned at one hundred and twenty degrees away from the adjacent webs (213). The webs (213) extends towards the base end from a concave inner surface (215) of the nipple end (205). The three leg shaped slit assist member (211) is aligned with the three intersecting webs (213) and is bonded to their edges as can be seen in FIG. 37. In FIG. 33 it can also be seen that the three slits (207) are each positioned in line with one of the three intersecting webs (213). In this way, each of the slits (207) is cut through the body (209) and extends a short distance into its adjacent web (213).

As with the earlier examples, the slit assist member (211) acts in two ways. Firstly, it is configured to assist the three intersecting webs (213) in keeping their respective slits (207) closed. And secondly, the slit assist member (211) is configured to assist each of the slits (207) by acting as a tear stopping device to slow down or stop the edges of the slits (207) that are situated in the web (213) from tearing and increasing in size during repeated usage.

To help the slit assist member (211) to achieve these two objectives, the slit assist member (211) is pre-tensioned during the time that the body member (209) is overmolded about the slit assist member (211).

Variations

Aspects of the present invention have been described by way of example only and it should be appreciated that modifications and additions may be made thereto without departing from the scope thereof.

Within the specification the term molding is used often. Teats are commonly made using injection molding techniques, or using compression or transfer presses. It is envisaged that the teats described herein could be manufactured using either method.

In the examples described herein the slits are generally formed by cutting the rubber of the teats after the rubber has cured. It is envisaged that the slits can also be formed in the teats during the curing process, by modifying the tooling appropriately to include a fine former for forming the slit.

### Definitions

Throughout this specification the word “comprise” and variations of that word, such as “comprises” and “comprising”, are not intended to exclude other additives, components, integers or steps.

### ADVANTAGES

Thus it can be seen that at least the preferred form of the invention provides artificial teats which have the following advantages over prior art artificial teats;
the artificial teats include slit assist members that are configured to help keep the slits in the teats closed in between suckling actions and when not in use, and
the artificial teats include slit assist members that are positioned and configured slow down or stop the tearing that occurs at the edges of the slits that are originally cut into, or formed in, the nipple end of the teats.

1. An artificial teat for infants or young animals, the artificial teat being made of an elastomeric material and having a base end and a nipple end, the base end being configured to mate with a container or liquid supply, and the nipple end having one or more slits through which a liquid is able to flow when an infant or young animal is suckling, and wherein the artificial teat includes a body member in which the or each slit is cut or formed, and at least one slit assist member, the or each slit assist member being formed or made separate to the body member and being integrated into the body member.

2. The artificial teat as claimed in claim 1, wherein the or each slit assist member is bonded to the body member.

3. The artificial teat as claimed in claim 1, wherein the or each slit assist member is situated within the nipple end of the artificial teat.

4. The artificial teat as claimed in claim 1, wherein the or each slit assist member is positioned in such a manner within the artificial teat that a part of the or each slit assist member is situated adjacent to an edge of the or each slit in the artificial teat.

5. The artificial teat as claimed in claim 1, wherein the or each slit assist member is positioned in such a manner within the artificial teat that a part of the or each slit assist member lies substantially at right angles to an adjacent edge of the or each slit in the artificial teat.

6. The artificial teat as claimed in claim 1, wherein the or each slit assist member is in the form of an elongate member.

7. The artificial teat as claimed in claim 1, wherein the or each slit assist member is substantially dogbone shaped.

8. The artificial teat as claimed in claim 1, wherein one or more of the slit assist members are in the form of an o-ring.

9. The artificial teat as claimed in claim 8, wherein the or each o-ring shaped slit assist member encircles a slit of the artificial teat.

10. The artificial teat as claimed in claim 8, wherein one or more o-ring shaped slit assist member includes a cap portion.

11. The artificial teat as claimed in claim 1, wherein the or each slit assist member is configured to assist in keeping the or each slit closed.

12. The artificial teat as claimed in claim 1, wherein the or each slit assist member is configured to assist by acting as a tear stopping device to slow down or stop the or each slit from tearing and increasing in size when in use.

13. The artificial teat as claimed in claim 1, wherein the artificial teat is formed by overmolding the body member over the or each slit assist member.

14. The artificial teat as claimed in claim 1, wherein the or each slit assist member is made from the same, or a similar, elastomeric material as the body member.

15. The artificial teat as claimed in claim 1, wherein the or each slit assist member is pre-tensioned during the time that the body member is overmolded about the or each slit assist member.

16. A feeding apparatus incorporating at least one artificial teat as claimed claim 1.

17. The feeding apparatus as claimed in claim 16, wherein the feeding apparatus includes at least one bottle, trough or milk supply apparatus.

18. A method of manufacturing an artificial teat as claimed in claim 1, wherein the method includes the steps of;
producing one or more slit assist members,
installing the or each slit assist member within the molding tooling for making the artificial teat, and
overmolding a body member of the artificial teat about the or each slit assist member.

19. The A-method of manufacturing an artificial teat as claimed in claim 18, wherein the method includes pre tensioning the or each slit assist member when installing said slit assist member it-into the molding tooling and during the overmolding step.

20. The artificial teat as claimed in claim 2, wherein the or each slit assist member is situated within the nipple end of the artificial teat.
